(19) United States
(12) Patent Application Publication
(10) Pub. No.: US 2023/0408319 A1
(43) Pub. Date: Dec. 21, 2023

(54) TOPOLOGY-ACQUIRING LEVEL GAUGE

(71) Applicant: VEGA Grieshaber KG, Wolfach (DE)

(72) Inventor: Steffen Wälde, Niedereschach (DE)

(21) Appl. No.: 18/250,614

(22) PCT Filed: Oct. 26, 2020
(86) PCT No.: PCT/EP2020/080067

§ 371 Date: Apr. 26, 2023

(51) Int. Cl. G01F 23/284; G01F 25/20

(52) U.S. Cl. CPC G01F 23/284; G01F 25/20

(57) ABSTRACT

The present invention relates to a topology-acquiring radar level gauge for measuring a fill level and a topology of a fill material, comprising: a radar unit; an antenna having at least one transmitting element and at least two receiving elements; a control unit; and a memory, in which at least two different sets of calibration data are stored in the memory.

The invention generally relates to filling level measurements. In particular, the invention relates to a filling level measuring device for determining a topology of a filling material surface, a method for determining a topology of a filling material surface, a program element for a filling level measuring device and a computer-readable medium with such a program element.

Various sensors for determining a filling level or limit level of filling material are known from the prior art. In particular, such a sensor may be a radar level measuring device. Radar level measuring devices of this type are equipped with horn antennas, for example, via which a high-frequency signal (HF signal) that has been coupled in is emitted in the direction of the bulk material. This HF signal is reflected by the bulk material, and the reflected signal is then received and evaluated by a combined transmitting/receiving system of the radar level measuring device. In the process, the filling level is determined based on the run time.

In such filling level measuring devices and also other sensors for determining a filling level or limit level known from the prior art, the filling level is respectively determined based on a measurement in a point or small region of the surface of the filling material onto which the emitted signal is focused. This is unproblematic in the case of liquids. They form a planar, purely horizontally extending surface and thus have a constant filling level across the entire surface. In the case of bulk materials, such as gravel or grain, however, such a filling level measurement known from the prior art is often inaccurate. Such bulk materials generally do not have purely horizontally oriented surfaces with a constant filling level. Rather, material cones may form due to the dumping of bulk material or the removal of bulk material, with the filling level being higher in some areas of the surface than in others. Moreover, an adherence of the bulk material to walls of containers may also occur, wherein these deviating filling levels also cannot be detected with filling level measuring devices known from the prior art.

The detection of a topology of a filling material surface may be advantageously applicable particularly in the case of measuring bulk material and the material cones and discharge cones often occurring inside or outside of closed containers in the process. The detection of a surface topology for determining filling levels and/or volumes may also be applicable in the case of moved liquids. Such moved liquids occur during the use of stirrers and in the flow patterns on the liquid surface generated thereby (so-called vortexes). A determination of the surface topology may permit conclusions to be drawn as to further quantities, such as a viscosity or level of mixing of a filling material, possibly taking into account a speed of the stirrer.

Methods for the contact-free scanning of a surface may be based on the principle, for example, that a signal emitted in the direction towards a surface is reflected thereby, and a run time and/or signal strength of the reflected signal is evaluated. In order to detect a topology of a filling material surface with sufficient accuracy, it may be necessary to carry out a plurality of measurements in the direction of certain regions of a filling material surface, which may increase a complexity and costs for such measuring devices or measuring methods.

FIG. 1 shows an exemplary embodiment of a topology-detecting filling level measuring device 100 according to the prior art. Such topology-detecting filling level measuring devices 100 are becoming increasingly important in filling level measuring technology. Apart from outputting a common filling level in the case of bulk materials, these devices supply additional information about the surface contour 107 of a material dump 108. Moreover, adhered material on the container walls can be detected. So far, only very few systems of this type are available on the market.

The filling level measuring device has a control unit 101 with an electrical control circuit 102, and an antenna device 104, hereinafter referred to as an antenna 104 in short. Such filling level measuring devices 100 are used, in particular, in bulk material measurements in a container 105 or on an open dump, wherein the course of the surface 107 of the bulk material 108 and/or the topology of the filling material surface 107 of the filling material 108 can be determined. The antenna device 104 has several transmitting and/or receiving elements 120, 122, which permits the main beam direction H and/or the main receiving direction H′ to be changed. Thus, echo signals and/or echo curves from the various main beam directions H and/or main receiving directions H′ can be detected.

The antenna 104 has a two-dimensional assembly of transmitting elements 120 and/or receiving elements 122. The beam deflection required for measuring the filling material surface 107 is in this case accomplished exclusively by electronic means, by methods for analog and/or digital beam deflection (beam forming). In this case, the main beam direction H and/or the main receiving direction H′ are altered electronically, i.e. without mechanically moving components of the filling level measuring device 100.

The topology-detecting filling level measuring device 100 shown in FIG. 1 has a multiple antenna system (MIMO), which makes the electronic pivoting of a main emission direction H without mechanically moved parts possible. This takes into account the fact that although mechanically pivoted antenna systems are technologically easy to construct, they have very complex and high-maintenance mechanics. In this case, the antenna 104 is formed by a multiple antenna system (MIMO) having a plurality of transmitting and receiving elements 120, 122 regularly distributed across an antenna surface 126. The number of channels that the multiple antenna system has results from the possible combinations of transmitting and receiving elements 120, 122. For example, if the multiple antenna system has three transmitting elements and four receiver elements, the device has 12 radar channels resulting from the respective combinations of transmitting and receiving elements. For example, channel 1 is formed by the combination of the transmitting element 1 and the receiving element 1, channel 2 by the combination of the transmitting element 1 and the receiving element 2, up to channel 12, which is formed by the combination of the transmitting element 3 and the receiving element 4.

Current radar chips, which were developed in the automotive field, or for the distance radar employed there, generally already contain three transmitting elements and four receiving elements, and thus have a corresponding number of channels.

The radar technology used in the automotive field, in the form of highly integrated radar systems in a radar chip (RSoC, Radar System on Chip) leads to a miniaturization and cost reduction of the respective electronic components.

In a MIMO system as it is shown in FIG. 1, a resultant transmission lobe of the multiple antenna system can be pivoted by means of a control of the transmitting elements that varies in its phase position. The resultant transmission lobe and the main emission direction H connected therewith results from a superposition of the transmission lobes 110, 112, 114 associated with the individual transmitting elements. In case of transmitting, the direction of the resultant main beam direction H of the transmitting array thus changes depending on the phase shift of the signals of the individual transmitting elements.

In the case of receiving, in which also a plurality of receiving elements receives the reflected transmission signal, the main receiving direction H′ may also be determined by means of an adjustable phase position. If different predetermined phase positions are assigned to the individual receiving elements, i.e. the respectively received signal is delayed in a certain predefined manner, this changes the main receiving direction H′ of the receiver array.

An array is understood to be a plurality of transmitting/receiving elements that are arranged in a certain predefined distance from one another.

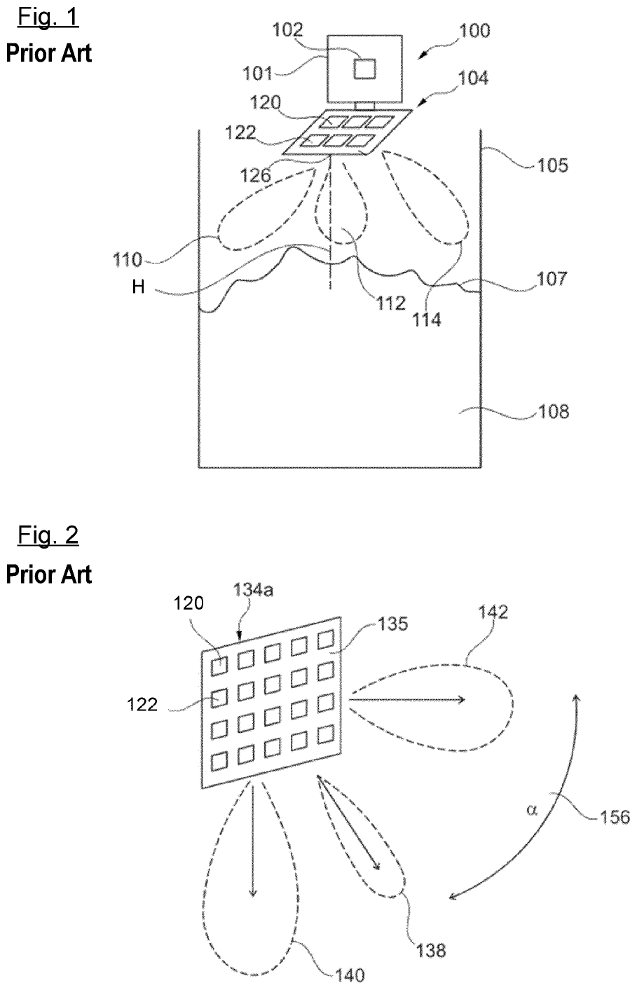

FIG. 2 shows an enlarged depiction of an antenna 135 with an array 134a consisting of several transmitting and/or receiving elements 120, 122. In this case, the transmitting and/or receiving elements 120, 122 are in this case distributed in a flat and/or uniform manner on an antenna surface 135. For example, the transmitting and/or receiving elements 120, 122 are arranged on the antenna surface 135 in lines and columns. In this case, a distance between two adjacent transmitting and/or receiving element 120, 122 is equal to or less than half the wavelength of the radar signal. FIG. 2 symbolically shows transmission and/or reception lobes 138, 140, 142 of individual transmitting and/or receiving elements 120, 122. A deflection angle 156 may be set using methods for digital beam forming. The deflection angle is in this case defined as the angle of the main emission direction H and/or the main receiving direction H′ of an antenna relative to the normal and/or the normal vector of the associated antenna surface 135. Theoretically, typical values in this case range from −60° to +60°, both for the azimuthal and elevational directions. Deflection angles 156 that can be set in reality are in the range of +/−45°, which can be accomplished with the methods for analog and/or digital beam deflection without too much loss with regard to the resulting half width of the antenna.

Since the obtainable deflection angle 156 is limited and the filling material surfaces in containers filled to a great extent, for example, cannot be acquired sufficiently, the filling level measuring device 100 may have a radar or an antenna assembly 130 comprised of several standalone partial radar groups in the form of several antennas. The overall radar antenna may then be a pyramid or truncated pyramid, for instance, wherein a partial radar group may be arranged on each partial jacket surface or antenna surface of the pyramid, and wherein analog and/or digital beam forming may be carried out with each partial radar group.

It is accomplished with such a multi-antenna configuration that an enhanced angular range can be scanned by means of a suitable control and evaluation.

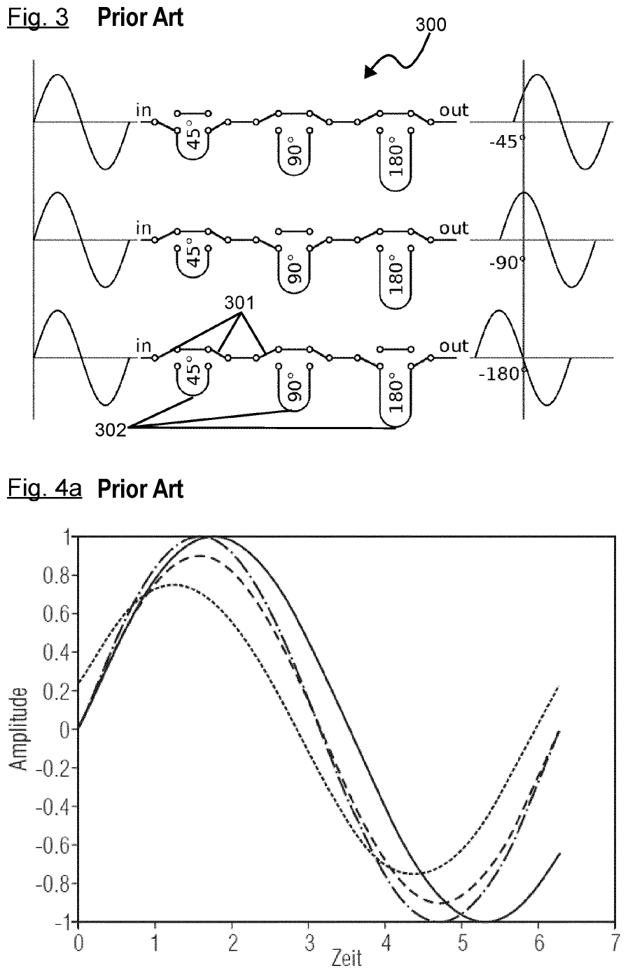

High-frequency phase shifters 300 are one way of varying the phases of the individual transmitting and receiving channels. A schematic diagram of such a high-frequency phase shifter 300 is shown in FIG. 3. In this high-frequency phase shifter 300, the high-frequency transmission or reception signal is delayed in relation to another channel by introducing an additional line 302 into the signal path. These lines 302 are connected or disconnected via switches 301, which may be configured as PIN diodes. A discrete delay can be set in this manner. Since periodic sinus signals are presumed, it only makes sense to delay the signal by maximally 360°. Realistic steps in the delay values are between 2 and 180°.

FIG. 3 shows, as an example, three parallel signal routes in which different lines 302 are connected into the signal path. The symbolically represented delaying elements for 45°, 90° and 180° may have any (predetermined and useful) different value and have significantly lower values for a finer adjustment of the phase shift. In addition, several delaying elements may be combined in a signal path.

Another, albeit uncommon, manner of varying the phases in case of transmission is to implement a phase shift already when the signal is being generated. If the signals for each transmitter are generated from separate phase-locked loops (PLL) synchronized with one another, adjustable phase shifts between the individual PLLs can also be implemented.

Another, very common manner of varying the phases in case of reception is not, as described above, to incorporate a phase shifter into the high-frequency path, but to apply the phase shift to the received signals in the digitized, low-frequency intermediate frequency range. This technique is known as digital beam forming.

One problem occurring with the multiple channel technique (MIMO) is that the channels, i.e. the above-described combinations of transmitting and receiving elements, have phase values, frequency values and amplitude values that slightly deviate from one another.

Compared with a mechanically pivoted topology-detecting radar device, however, the following problem occurs in a multi-channel radar device 100.

In a single-target scenario with an FMCW radar (frequency modulated continuous wave radar), each channel generates a sinus oscillation as an output signal. The phase and frequency of the sinus oscillation are proportional to the distance of the target; the amplitude is a measure for the reflective properties of the target.

Various influences, such as slightly different line lengths and/or different line attenuation, different capacitive and/or inductive influences in, for example, soldered connections, production tolerances in the chips, on the circuit board and/or in the antennas, give rise to varying phase and amplitude conditions of the channels, and thus to deviations between the channels, which should not exist based on theoretical considerations.

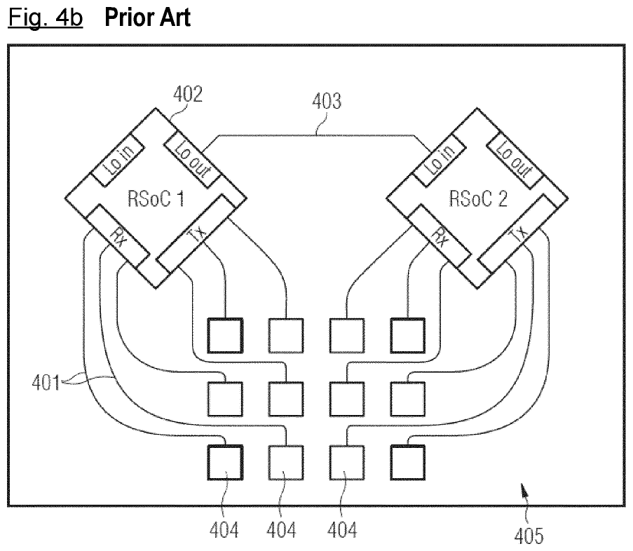

FIG. 4a shows the output signals of different transmitting elements by way of example. As is apparent from the illustration in FIG. 4a, the signals have amplitudes deviating from one another, and are phase-shifted relative to one another.

As regards the construction, possibly not all channels can be formed with exactly the same line lengths. This problem is illustrated in FIG. 4b. FIG. 4b shows an exemplary embodiment of a radar level measuring device in which two integrated radar systems (RSoC) 402 are operated with a common antenna. Due to the different lengths of the lines 401 between the signal outputs and inputs Tx, RX of the integrated radar systems (RSoC) 402 and the transmitting and/or receiving element 404 of the common antenna, a phase shift between the individual channels is also generated. This problem becomes worse if several integrated radar systems (RSoC) 402 are used on a common circuit board 405. The two integrated radar systems (RSoC) 402 in FIG. 4b are connected to each other and synchronized via a local oscillator LO and an associated line 403.

As is apparent from FIG. 4b, high-frequency lines 401 of different lengths are necessary in order to connect the integrated radar systems (RSoC) 402 with one another and with the transmitting and receiving elements 404. In turn, this results in further amplitude, frequency and phase shifts or signal run times of the individual channels.

For the above-mentioned reasons, a calibration of a MIMO radar system is necessary. In the process, different signal run times and amplitude fluctuations are removed by calibration, i.e. the input signals and the output signal processing are adapted such that the above-mentioned deviations are compensated.

For this purpose, a single-target scenario is simulated in which all channels are measured. The sinus signals resulting therefrom are analyzed, and the deviations regarding the amplitude, phase and frequency from a reference signal are calculated. These deviations are determined in the form of coefficients and stored. The reference signal may be the measured signal of channel 1, for instance. In that case, channel 2 has an amplitude higher by 0.2 dB, a frequency deviation of 20 Hz and a phase deviation of 30°, for example.

These deviations, which constituted the calibrating data, are then taken into account in measurements in a real environment. Depending on the beam forming principle, they may be taken into account in the measurement in different ways.

In analog beam forming with phase shifters, the phase shifters may be set such that they compensate the faulty run times. In addition, adjustable transmission or reception amplifiers are used, which correct the deviations with regard to the amplitude. However, this type of compensation entails additional hardware expenditure. Moreover, the faults can only very inaccurately be removed from the systems by calibration because phase shifters, for example, cannot be adjusted arbitrarily finely, since they operate with discrete switching steps.

In contrast, digital beam forming on the receiver side offers enormous advantages. Here, calibrating data can be taken into account in a very comfortable manner. Moreover, the calibrating data can be stored and processed with much greater accuracy. While an accuracy of only 5 to 8 bits can be realized in the case of analog phase shifters, 16 or 32 bits can be realized with digital technology.

In the multi-channel radar systems calibrated in this manner, there is still the problem, however, that both environmental influences and the measuring distance cause inaccuracies of measurement. There is therefore a need for topology-detecting radar systems with an increased measuring accuracy.

It is the object of the invention to provide a topology-detecting radar level measuring device having an increased measuring accuracy. Moreover, one object is to specify a method for calibrating a topology-detecting radar level measuring device and a method for operating such a radar level measuring device.

These objects are achieved by means of a topology-detecting filling level measuring device with the features of patent claim 1, a method for calibrating a topology-detecting radar level measuring device according to patent claim 10, and a method for operating a topology-detecting radar level measuring device with the features of patent claim 12. Patent claim 18 specifies a computer program code that implements the method as software.

Preferred embodiments, features and properties of the proposed field device correspond to those of the proposed method and vice versa.

Advantageous embodiments and variants of the invention become apparent from the dependent claims and the following description. The features cited individually in the dependent claims may be combined in any technologically meaningful manner both with each other and with the features presented in more detail in the following description, and can represent other advantageous embodiment variants of the invention.

A topology-detecting radar level measuring device according to the invention, for determining a filling level and a topology of a filling material with a radar unit, an antenna with at least one transmitting element and at least two receiving elements, with a control unit and a storage is characterized in that at least two different sets of calibrating data are stored in the storage.

Because at least two different sets of calibrating data are stored in the storage, it is possible to calibrate the radar level measuring device to different environmental conditions. In this sense, calibrating means that errors of control and/or signal evaluation caused by environmental conditions are compensated by suitable calibration coefficients in the transmission signals and/or reception signals. By suitable selection, the different sets of calibrating data make it possible to adjust the radar level measuring device to different environmental conditions and thus, adapted to these environmental conditions, to use compensated signals and/or use correspondingly adapted signal processing.

In this sense, environmental conditions are all external influences that have an effect on the filling level measurement and/or on topology detection. For example, and not limited thereto, these are a temperature in the process environment and/or a temperature of the antenna and/or a temperature of the electronics and/or a temperature in the environment of the filling level measuring device outside of the process environment and/or a distance of the filling material from the antenna and/or an installation position of the filling level measuring device and/or an air humidity in the process environment, the electronics or outside, in the environment of the filling level measuring device.

Different sets of calibrating data are sets of calibrating data determined for different environmental conditions. By means of at least two sets of calibrating data, different ranges of the individual environmental conditions and combinations of the various environmental conditions can be taken into account with their own set of calibrating data in each case. In this manner, the measurement can be optimized and the measurement result improved.

In the simplest case, given largely constant and known environmental conditions, the user can select the set of calibrating data that is most suitable when starting up the topology-detecting radar level measuring device, and thus adapt the measurement to the respective environmental conditions.

As was already described above, the antenna may also consist of several partial antennas, in order to cover, by cleverly arranging the partial antennas relative to one another, a larger angular range as a detection area with the overall antenna, i.e. with the combination of the partial antennas.

Preferably, the topology-detecting filling level measuring device is a radar level measuring device in which the main emission direction is changed exclusively electronically, in particular by means of digital and/or analog beam forming and, optionally, by using several antennas and a suitable interconnection therefor.

In order to make an automated switchover between the different set of calibrating data possible, the radar level measuring device may be suitably configured to determine at least one further measurement value in addition to the filling level and the topology. The one or the several measurement values may be selected, for example, from the group including temperature, air humidity, distance, position and other relevant measurement values for environmental conditions or the quantities linked thereto. The further measurement values may be determined by means of the radar sensor itself, by means integrated in components of the radar sensor or in the electronics. The integrated means are not absolutely required to be separate sensors but may include any means that permit a determination of relevant environmental conditions or a quantity linked thereto.

The temperature of the individual components, in particular, may affect the quality of the measurement because, for example, the line lengths for connecting the transmitting and/or receiving elements to a radar unit in which the signal generation takes place may vary due to effects of thermal expansion. Thus, a temperature-dependent phase shift in the control of the individual transmitting elements is produced. Equally, a phase shift between the individual signals occurs in the signal transmission of the received signals from the receiving elements for evaluation in the high-frequency unit, for example.

Moreover, the calibrating data sets may differ for different distance ranges.

Moreover, the calibrating data sets may also be dependent on the installation position of the radar level measuring device. If a radar level measuring device is not installed exactly vertically, for example, it may be necessary to adjust the perpendicular direction by suitably selecting the calibrating data.

In this way, a set of calibrating data used for measuring the filling level and topology may be selected depending on the further measurement value or values. This makes it possible to select for each individual measurement the optimum set of calibrating data adapted to the environmental conditions.

The radar level measuring device may have at least one additional sensor for this purpose. In particular, the radar level measuring device may have several, in particular two, three, four, five or more additional sensors. Using the additional sensor, the respective environmental conditions or quantities linked therewith can be determined and used for selecting a set of calibrating data.

At least one of the additional sensors of the radar measuring device may be a temperature sensor. Moreover, the radar measuring device may have several temperature sensors in order to permit a redundant measurement and/or to determine several temperatures at different locations of the radar sensor, for example, in order to determine a temperature difference between two or more locations on the radar sensor.

For example, a temperature sensor may be arranged such that a temperature of the antenna and/or of the process environment can be determined. In this case, the temperature sensor may be arranged such, particularly in an area of the antenna or of the housing, that a temperature of the antenna and/or of the process environment can be determined, i.e. the sensor may be located, in particular, on or in the antenna.

Additionally or alternatively, a temperature sensor may be arranged in the area of an electronic system, i.e. in particular be arranged such, on or in the electronic system, that a temperature of the component of the electronic system of the radar level measuring device can be determined.

Additionally or alternatively, a temperature sensor may be arranged such that an ambient temperature of the radar level measuring device can be determined, particularly a temperature outside of a housing of the radar level measuring device outside the process environment.

Additionally or alternatively, the radar measuring device may have as the additional sensor at least one distance sensor for determining a distance of the filling level from the antenna. Due to the at least one dedicated distance sensor, a distance measurement becomes independent of the radar level measuring device. For example, the distance sensor may be configured as a further radar sensor and/or as an ultrasonic sensor and/or as an optical distance sensor. Due to a distance measurement independent of the radar measuring device, a selection becomes possible of a set of calibrating data that is dependent on a distance of the filling material surface from, for example, the antenna of the radar level measuring device, which is independent of a possible distance-related measuring inaccuracy because of the alternative sensor. The additional distance sensor may be arranged in or next to the antenna, for example.

Additionally or alternatively, the radar measuring device may further have as an additional sensor a position sensor. A deviation of the installation position of the radar level measuring device from a position in which the surface normal of the antenna is perpendicularly oriented can be determined by the position sensor, for example, and an orientation of the main emission direction can be corrected by calibrating factors in accordance with the determined deviation.

In a configuration with several partial antennas, and depending on the structure of the antenna, the axis of symmetry of the partial antennas may be used, for example, as a reference axis for the determination of an orientation of the antenna, and in accordance with a deviation of this axis from the perpendicular, a correction can be carried out by corresponding calibrating factors. Additionally or alternatively, the radar measuring device may have a moisture sensor, e.g. a hydrometer.

A method according to the invention for calibrating a topology-detecting radar level measuring device for determining a filling level and a topology of a filling material with a radar unit, an antenna with at least one transmitting element and at least two receiving elements, with a control unit and a storage is characterized in that at least two different sets of calibrating data are determined and stored in the storage during a calibration of the radar level measuring device.

A determination of at least two different sets of calibrating data offers the possibility of the topology-detecting radar level measuring device being calibrated under different environmental conditions. By selecting a corresponding set of calibrating data, an optimized operation of the radar level measuring device under different environmental conditions is made possible.

Different sets of calibrating data are not necessarily different with regard to the stored calibrating factors, but may also differ only in the underlying environmental conditions.

The at least two different sets of calibrating data are preferably determined depending on a temperature and/or an air humidity and/or a distance and/or a position of the sensor. For each environmental condition, i.e. temperature, position and distance, in particular, various ranges may be defined in this case, in which a change of the respective environmental condition has no, or only a negligible, influence on the calibrating function. For all combinations of the environmental conditions deemed relevant or combinations of the respective ranges of environmental conditions, separate sets of calibrating data may further be determined and stored.

A method according to the invention for operating a topology-detecting radar level measuring device for determining a filling level and a topology of a filling material with a radar unit, an antenna with at least one transmitting element and at least two receiving elements, with a control unit and a storage with at least two sets of calibrating data is characterized in that one of at least two sets of calibrating data is selectable.

Due to the possibility of selecting one of at least two sets of calibrating data, the radar level measuring device can be calibrated for different calibrating conditions, i.e. the environmental conditions under which the calibration took place. It is possible to calibrate the radar level measuring device for different environmental conditions and thus optimize the measurement.

As a rule, calibration is carried out in the factory. The different calibrating data sets are stored in the device and recorded in a precisely defined measuring environment.

In this case, the set of calibrating data can be selected by a user. If, in a simple scenario, it is known, for example, in which temperature range a radar level measuring device is being operated, then a set of calibrating data can be selected during start-up and used from now on for measuring.

Alternatively, the set of calibrating data can be selected depending on environmental conditions of the radar level measuring device. This is to be understood to mean that an automated selection of the set of calibrating data takes place depending on the environmental conditions. Thus, compared to a manual selection, an automated selection can take place, which can be updated during the measuring operation in between two measurements.

Preferably, the set of calibrating data is selected depending on a temperature and/or an air humidity and/or a distance and/or a position.

A frequency of the selection of the set of calibrating data is preferably configured to be dependent on a rate of change of environmental conditions and a measuring frequency. If, for example, different sets of calibrating data are available for different temperature ranges, with a temperature range including 20°, and if a temperature changes very slowly, e.g. at a maximum rate of 10° per hour, then, given a measuring frequency of one measurement per minute, it is not necessary to check the selection of the calibrating data prior to each measurement, but it may be sufficient to provide a check and selection of the calibrating data for every tenth measurement. Alternatively, given rapidly changing environmental conditions and/or an, in comparison therewith, low measuring frequency, it may be necessary to check the selection of the proper calibrating data prior to each measurement.

If possible with the available resources, particularly the available energy and/or available computing power, it is to be preferred to select the set of calibrating data prior to each measurement depending on the respectively current environmental conditions.

The present invention is explained in detail below based on exemplary embodiments with reference to the attached Figures. In the Figures:

FIG. 1 shows an exemplary embodiment of a topology-detecting radar level measuring device according to the prior art (already addressed),

FIG. 2 shows an enlarged illustration of an antenna device as it may be used in the exemplary embodiment according to FIG. 1 (already addressed),

FIG. 3 shows a schematic diagram of an analog phase shifter (already addressed),

FIG. 4a shows transmission signals as they may be used without calibration in the exemplary embodiment according to FIG. 1 (already addressed),

FIG. 4b shows an exemplary embodiment with two integrated radar systems with a common antenna (already addressed),

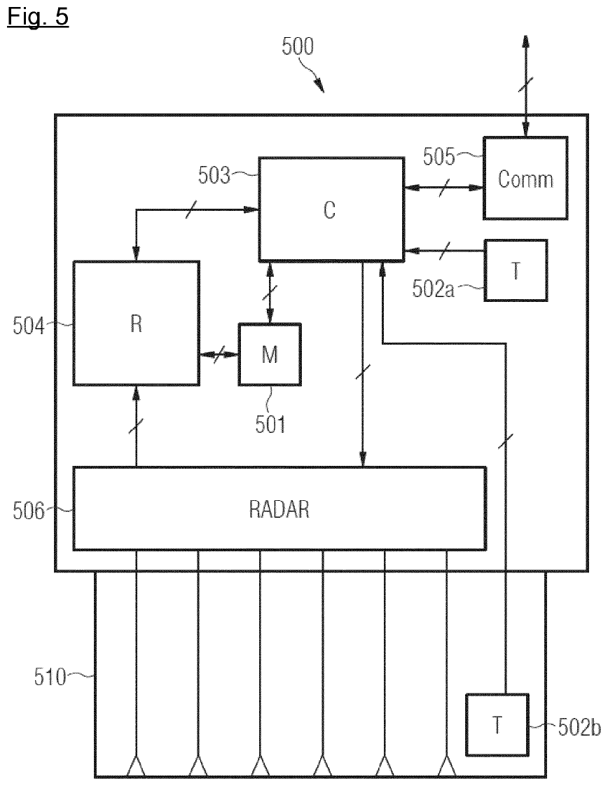

FIG. 5 shows a first exemplary embodiment of a topology-detecting radar level measuring device according to the present application, and

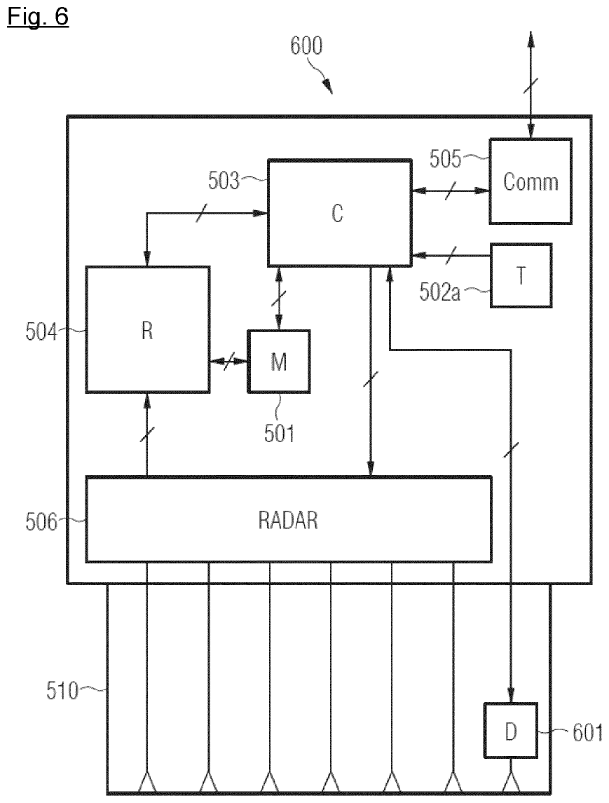

FIG. 6 shows a second exemplary embodiment of a radar level measuring device according to the present application.

Unless otherwise stated, identical reference numerals in the Figures denote identical components, or components corresponding to one another, with the same function.

FIG. 5 shows a block circuit diagram of a first exemplary embodiment of a topology-detecting radar level measuring device 500 according to the present application.

The topology-detecting radar level measuring device 500 has an antenna 510 that is supplied by an integrated radar system (RSoC) 506 and transmits received signals to this integrated radar system (RSoC) 506. The antenna 510 is formed by a number of transmitting and/or receiving element arranged in an array.

The integrated radar system 506 is controlled by a control unit 503 configured as a controller. The received signals are processed by a computing unit 504, which may be realized as an FPGA. Besides the radar unit 506, which may contain between 2 and more than 1000 radar channels, the computing unit 504 is responsible for receiving the received signals of the individual radar channels, which are digitized into received data, and apply various linear computing operators to the measurement data. The computing unit 504 may be realized by an FPGA (Field Programmable Gate Array). The linear computing operators contain the calibration of the field device in the receiving direction, multi-dimensional windowing operations and multi-dimensional FFTs (Fast Fourier Transformation). Other filter operations and a data reduction may also be processed therein.

Both the control unit 503 and the computing unit 504 are connected to a storage M in which a plurality of sets of calibrating data for different environmental conditions is stored.

The topology-detecting radar level measuring device 500 is designed to adapt the calibrating data dynamically to the environmental conditions during operation, i.e. to select the suitable set of calibrating data depending on the respectively existing environmental conditions. Thus, the radar level measuring device possesses not only a single calibrating data set, but several, and for this purpose has a storage unit 501 dimensioned with a sufficient size. The calibrating data sets are adapted to different environmental conditions.

For this purpose, the radar level measuring device has further sensors measuring environmental properties that have an influence on the measuring accuracy.

In the exemplary embodiment shown in FIG. 5, the radar level measuring device has several temperature probes 502a, 502b, of which the one temperature probe 502a is arranged in the electronics and the other temperature probe 502b is arranged in the area of the antenna 510. Thus, the temperature of the electronics and its environment and of the antenna 510 and its environment can be monitored. The control unit 503 can read out the temperatures and specifies to the computing unit 504, which is responsible for computing the bulk material surface on the basis of the received data, which calibrating data are to be used. The control unit 503 itself can also use the suitable set of calibrating data for controlling the radar system 506.

For example, three different sets of calibrating data may be provided for the process temperature ranges of between −40° C.-0° C., 0° C.-50° C. and 50° C.-100° C. In accordance with the process temperature, the control unit 503 selects the corresponding data set.

A communication with a higher-level unit, e.g. a control center, may take place via a communication module 505.

Another exemplary embodiment is shown in FIG. 6.

The radar level measuring device 500 disclosed therein has distance-dependent calibrating data. Depending on the distance from the filling material, i.e. particularly depending on the filling level, the control unit 503 can select the calibrating data set to be used. The distance or filling level may be determined either by means of a distance sensor 601, which is configured as an additional integrated filling level measuring device, for instance, or alternatively from the data of the topology-detecting radar system. For increasing the reliability of measurement, a combination of the two systems is also conceivable. In this case, the distance sensor 601 may be based on an acoustic, optical or radar-based measuring method, for instance.

Moreover, a combination of the temperature and the distance may also be used for determining the suitable set of calibrating data—the calibrating data are to be stored in the storage 501 accordingly when calibrating the radar level measuring device.

In this case, it is conceivable that the environmental parameters are determined by means of the additional environmental sensors 501a, 502b, 601 prior to each topology-detecting measurement. Thereupon, the control unit decides which calibrating data set is to be used for the following measurement. It is also conceivable that the environmental sensors are not read out prior to each measurement, because these are, in part, slow processes, and the measurement rate of the topology detection is significantly higher compared thereto. For example, the measurement rate for topology detection may be 5 measurements per minute, whereas a temperature change by 20° C. may take several hours. In this case, it would be sufficient if the temperature measurement took place only every 20 measurements, for instance.

In another variant, the calibrating data to be used for topology detection may also be set by a user. To this end, the set of calibrating data to be used may be selected via the communication interface 505, for instance. It is also conceivable that a user is able to upload completely new calibrating parameters via the communication interface 505. The measurement values can also be transmitted to the process control system via this communication interface 505.

### REFERENCE SIGNS LIST

100 Topology-detecting filling level measuring device
101 Control unit
102 Electrical control circuit
104 Antenna device (short: antenna)
105 Container
107 Surface contour
108 Material dump
110, 112, 114 Transmission lobes
120 Transmitting element
122 Receiver element
126 Antenna surface
130 Radar or antenna assembly
135 Antennas
134a Array
138 Transmission and/or reception lobe
140 Transmission and/or reception lobe
142 Transmission and/or reception lobe
156 Deflection angle
300 High-frequency phase shifter
301 Switch
302 Line
401 Lines
402 Radar unit, integrated radar system (RSoC)
403 Line
404 Transmitting and receiving elements
405 Circuit board
500 Topology-detecting radar level measuring device
501 Storage Unit
501a Environmental sensor
502a, 502b Temperature probe
503 Control unit
504 Computing unit
505 Communication module
506 Radar unit, integrated radar system (RSoC)
510 Antenna
601 Distance sensor

1. A topology-detecting radar level measuring device for determining a filling level and a topology of a filling material, comprising
a. a radar unit,
b. an antenna with at least one transmitting element and at least two receiving elements,
c. a control unit and
d. storage
wherein at least two different sets of calibrating data are stored in said storage.

2. The topology-detecting radar level measuring device according to claim 1, wherein the radar level measuring device is configured to determine at least one further measurement value in addition to the filling level and the topology.

3. The topology-detecting radar level measuring device according to claim 2, wherein a set of calibrating data used for measuring the filling level and topology is selected depending on the further measurement value.

4. The topology-detecting radar level measuring device according to claim 1, wherein the radar level measuring device has at least one additional sensor.

5. The topology-detecting radar level measuring device according to claim 4, wherein the additional sensor comprises at least one temperature sensor.

6. The topology-detecting radar level measuring device according to claim 5, wherein said temperature sensor is disposed in the region of the antenna.

7. The topology-detecting radar level measuring device according to claim 5, wherein said temperature sensor is disposed in the region of an electronic system.

8. The topology-detecting radar level measuring device according to claim 4, wherein the additional sensor comprises a distance sensor for determining a distance of the filling level from the antenna.

9. The topology-detecting radar level measuring device according to claim 4, wherein the additional sensor comprises a position sensor.

10. A method for calibrating a topology-detecting radar level measuring device for determining a filling level and a topology of a filling material with a radar unit, the device comprising an antenna with at least one transmitting element and at least two receiving elements, a control unit and storage, the method comprising
a. determining at least two different sets of calibrating data and
b. storing said two different sets of calibrating data in said storage during a calibration of the radar level measuring device.

11. The method according to claim 10, wherein the at least two different sets of calibrating data are determined depending on a temperature and/or a distance and/or a position of the radar level measuring device.

12. A method for operating a topology-detecting radar level measuring device for determining a filling level and a topology of a filling material with a radar unit, the device comprising an antenna with at least one transmitting element and at least two receiving elements, a control unit and storage containing at least two sets of calibrating data, the method comprising selecting one of said at least two sets of calibrating data.

13. The method according to claim 12, wherein a set of calibrating data is selected by a user.

14. The method according to claim 12, wherein a set of calibrating data is selected depending on environmental conditions of the radar level measuring device.

15. The method according to claim 14, wherein a set of calibrating data is selected depending on a temperature and/or a distance and/or a position.

16. The method according to claim 12, wherein a frequency of selection of a set of calibrating data is dependent on a rate of change of environmental conditions and a measuring frequency.

17. The method according to claim 12, wherein a set of calibrating data is selected prior to each measurement.

18. A computer program code which, when executed by a processor of a topology-detecting radar level measuring device, causes the latter to execute the method according to claim 12.
